(19) United States
(12) Patent Application Publication
(10) Pub. No.: US 2015/0104776 A1
(43) Pub. Date: Apr. 16, 2015

(54) DEMONSTRATION MODEL FOR GEOLOGIC EVENT

(71) Applicant: William E. Ohlsson, JR., Canton, MI (US)

(72) Inventor: William E. Ohlsson, JR., Canton, MI (US)

(21) Appl. No.: 14/512,775

(22) Filed: Oct. 13, 2014

Related U.S. Application Data
(60) Provisional application No. 61/889,600, filed on Oct. 11, 2013.

(51) Int. Cl. G09B 23/40

(52) U.S. Cl. CPC G09B 23/40
USPC 434/299

(57) ABSTRACT

A kit of components to form a model of geological processes is presented. The kit contains a first foam component defining a first concave internal surface, a convex first exterior surface, and a first locking surface therebetween. An upper member defines an aperture that accepts a reaction chamber. The reaction can be a PET bottle configured to hold reaction components.

### CROSS-REFERENCE TO RELATED APPLICATIONS

This application claims the benefit of U.S. Provisional Application No. 61/889,600, filed Oct. 11, 2013. The entire disclosure of the above application is incorporated herein by reference.

### FIELD

The present disclosure relates to an educational kit to replicate natural geological processes and, more particularly, to an educational kit to replicate a volcano.

### BACKGROUND

This section provides background information related to the present disclosure which is not necessarily prior art.

An important part of elementary school education is the study of natural phenomena. Along with the study of biology and weather, students often have a study unit on geological processes which affect the topography of the earth's surface. These units include, for instance, studies in plate tectonics, earthquakes, and volcanoes. Students are often asked to make models of these geological events. While a great learning experience, the creation of these models can often be frustrating for especially young students.

### SUMMARY

This section provides a general summary of the disclosure, and is not a comprehensive disclosure of its full scope or all of its features.

To overcome the deficiencies of the prior art, what is needed is a kit of components that makes the creation of a geologic model simple.

According to the present teachings, an educational kit of components is provided. The kit includes a plurality of interlocking foam elements which can form a representation of a geologic process.

According to another embodiment of the disclosure, a kit of components to form a model volcano is presented. The kit contains a first foam component defining a first concave internal surface, a convex first exterior surface, and a first locking surface therebetween. The kit contains a second foam component defining a second concave internal surface, and a second locking surface configured to interface with the first locking surface. The kit further contains a third foam piece configured to interface with the first and second foam components, the first foam component defining an aperture configured to accept the mouth of a bottle, the bottle configured to accept chemical reactants.

According to another embodiment of the disclosure, a kit of components to form a model volcano is presented. The kit of components for simulating a geographic process has a reaction chamber defined by a bottle. The kit further has a first foam component defining a first concave internal surface, a convex first exterior surface, and first and second locking surfaces; and a second foam component defining a second concave internal surface, and third and fourth locking surfaces, the third locking surface configured to interface with the first locking surface. A third top foam component is configured to interface with the second and fourth locking surfaces, the third foam component defines an aperture configured to accept the threaded mouth of a PET bottle. The reaction chamber is configured to accept chemical reactants.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 represents a perspective view of an assembled volcano according to the present teachings;

FIG. 2 represents a second view of the construction shown in FIG. 1; and

FIG. 3 represents an exploded perspective view of the construction shown in FIG. 1.

Corresponding reference numerals indicate corresponding parts throughout the several views of the drawings.

### DETAILED DESCRIPTION

Example embodiments will now be described more fully with reference to the accompanying drawings.

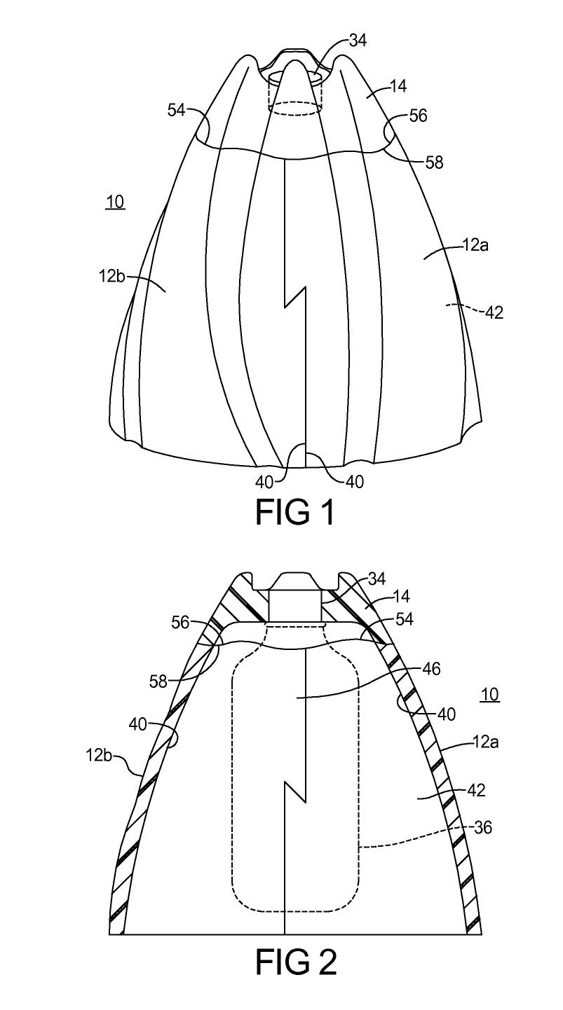

FIGS. 1-3 represent an educational kit 10 to replicate a volcanic eruption. The kit 10 can be formed of a plurality of interlocking foam pieces 12a-14 which have an exterior surface 16 that simulates a volcano such as a cone volcano. The exterior surface 16 has a generally convex surface that defines a plurality of grooves 18 that present channels for the flow of chemical reactants as described below.

As described in detail below, the first foam component 12a defines a first concave internal surface, a convex first exterior surface, and a first locking surface. The kit contains a second foam component defining a second concave internal surface, and a second locking surface configured to interface with the first locking surface. The kit further contains a third foam piece configured to interface with the first and second foam components, the first foam component defining an aperture configured to accept the mouth of a bottle (e.g. a 1 liter PET bottle), the bottle configured to accept chemical reactants.

The top foam piece 14 defines an outer surface that has a caldera 20, and may define an anatomy of a volcano, including a lava dome 22 and vent 24. Additionally, the exterior of the interlocking foam pieces 12a-14 can be textured to represent flowing lava 26, fissures 28, Lattar 30, or ash 32.

The top foam piece 14 defines an aperture 34 which is configured to accept the mouth of a threaded bottle 36 (See FIG. 2). Optionally, a polymer ring (not shown) can be provided on the top component 14 to accept the bottle 36.

Each of the interlocking foam pieces 12a-14 can define a concave interior surface 40 that allows the interlocking foam pieces 12a-14 to be nested and placed within a sales box (not shown). The concave interior surface 40 defines a cavity 42 when the interlocking foam pieces 12a-14 are assembled. Disposed within and annularly disposed by the cavity 42 can be the one liter bottle 36 which is accepted and optionally supported by the aperture 34.

As shown in FIG. 2, the bottle 36 is configured to accept a plurality of reactant to simulate a volcanic eruption. These reactants can include vinegar and baking soda. In addition to the reactants, other materials such as a surfactant and food coloring can be used. Example embodiments are provided so that this disclosure will be thorough, and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

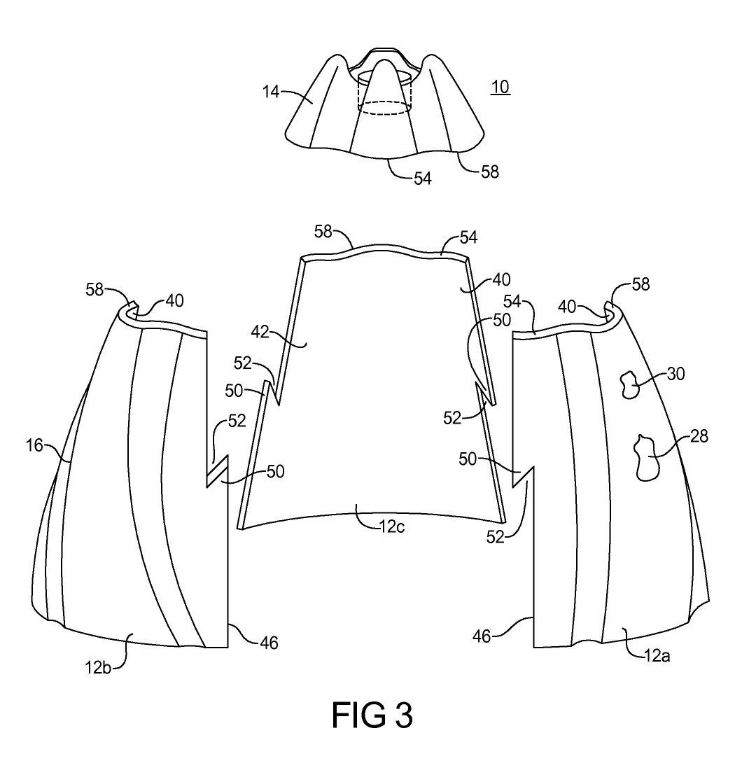

As shown in FIG. 3, the kit 10 forms a self-standing and self-supporting structure. Each of the interlocking foam pieces 12a-14 can have interlocking interface surfaces 46 that are configured to engage and lock to each other. This locking can be from friction defined between the interface surfaces 46. Additionally, the surfaces 46 can have a flange 50 that interfaces into a channel 52 defined in the interface surface 46. The interfacing surfaces 46 are configured to support the foam pieces 12a-14 in place under the force of gravity when assembled and when the bottle 36 is filled with reactants.

It is envisioned that the interface surfaces 46 can be configured to allow the volcano to be constructed in only a single configuration. Disposed between the interlocking foam pieces 12a-14, top member 14, and side members 12a-12c) is a bearing interface 54 between a top surface 56 and side bearing surfaces 58. The interface 54 can be keyed so as to encourage the proper alignment of the interlocking foam pieces 12a-14.

The kit of components for simulating a geographic process has a bottle having a mouth and de fining a reaction chamber. The reaction chamber is configured to accept chemical reactants. A first foam component defines a first internal surface that can be concave. The first foam component has an exterior surface that can be convex and a pair of locking surfaces. A second foam component defining a second internal surface that can be concave, and third and fourth locking surfaces. The third locking surface is configured to interface with the first locking surface. One of the first and second foam components define a portion of an aperture configured to be annularly disposed about the mouth of the bottle. The first and second foam components define a planar surface (the bottom) when the third locking surface interfaces with the first locking surface. While the bottle can be made of any suitable polymer capable of accepting vinegar and baking soda the bottle comprises PET. As described above, the reaction chamber comprises vinegar and baking soda, and surfactant and food coloring.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. The kit of components for simulating a geographic process comprising:
a bottle having a mouth and defining a reaction chamber, the reaction chamber configured to accept chemical reactants;
a first foam component defining a first concave internal surface, a convex first exterior surface, and first and second locking surfaces;
a second foam component defining a second concave internal surface, and third and fourth locking surfaces, the third locking surface configured to interface with the first locking surface; and
a third foam component configured to interface with the second and fourth locking surfaces, the third foam component defining an aperture configured to accept the mouth of the bottle.

2. The kit of component according to claim 1, wherein the first and second concave internal surfaces are annularly disposed about the reaction chamber.

3. The kit of components according to claim 1, wherein the reaction chamber is a PET bottle.

4. The kit of components according to claim 1, wherein the reaction chamber comprises vinegar and baking soda.

5. The kit of components according to claim 4, wherein the reaction chamber comprises surfactant and food coloring.

6. The kit of components for simulating a geographic process comprising:
a first container defining a first cavity and a mouth fluidly coupled to the first cavity, the first cavity configured to accept chemical reactants;
a first foam component defining a first internal surface, a convex first exterior surface, and first and second locking surfaces;
a second foam component defining a second internal surface, and third and fourth locking surfaces, the third locking surface configured to interface with the first locking surface; and
a third foam component configured to interface with the second and fourth locking surfaces, at least one of the first, the second and the third foam component defining a portion of an aperture configured to accept the mouth of the first container.

7. The kit of component according to claim 6, wherein the first, second and third components are annularly disposed about the first container.

8. The kit of components according to claim 6, wherein the first container is a polymer bottle.

9. The kit of components according to claim 6, wherein the first cavity comprises vinegar and baking soda.

10. The kit of components according to claim 9, wherein the first container comprises surfactant.

11. The kit of components for simulating a geographic process comprising:
a bottle having a mouth and defining a reaction chamber, the reaction chamber configured to accept chemical reactants;
a first foam component defining a first concave internal surface, a convex first exterior surface, and first and second locking surfaces;
a second foam component defining a second concave internal surface, and third and fourth locking surfaces, the third locking surface configured to interface with the first locking surface; and
wherein one of the first and second foam components define a portion of an aperture configured to be annularly disposed about the mouth of the bottle.

12. The kit of component according to claim 11, wherein the first and second foam components define a planar surface the third locking surface interfaces with the first locking surface.

13. The kit of components according to claim 12, wherein the bottle comprises PET.

14. The kit of components according to claim 13, wherein the reaction chamber comprises vinegar and baking soda.

15. The kit of components according to claim 14, wherein the reaction chamber comprises surfactant and food coloring.
